(19) United States
(12) Patent Application Publication
(10) Pub. No.: US 2005/0276939 A1
(43) Pub. Date: Dec. 15, 2005

(54) Illuminated halloween bag

(76) Inventor: John Dreika, Sarnia (CA)

Correspondence Address: Elias C. Borges, Suite 406, 1 Eva Road, Toronto, ON, M9C 4Z5, CA

(21) Appl. No.: 10/863,492

(22) Filed: Jun. 9, 2004

(51) Int. Cl. B27N 1/00

(52) U.S. Cl. 428/35.7

(57) ABSTRACT

An improved glow in the dark trick-or-treat bag is disclosed having superior glow characteristics and physical characteristics. The bag is made of an envelope of a flexible glow in the dark film material, the envelope having sealed side edges, a sealed bottom and an open top. The flexible film material is made from a mixture of a polymeric material with a glow in the dark additive. The film may be multi-layered film having a reflective layer, a clear layer and a glow layer sandwiched between the reflective layer and the glow layer. The glow layer is preferably between about 0.001″ to about 0.006″ in thickness and has a glow additive concentration preferably between about 7% and about 50%.

### FIELD OF THE INVENTION

The invention relates generally to Halloween bags and trick-or-treat bags.

### BACKGROUND OF THE INVENTION

Halloween is a popular holiday among young children. Children will go out on Halloween night into their neighborhood and canvas their neighbors for candy or other treats (referred to as trick-or-treating). They usually carry a bag or small bucket in order to receive the treats. Generally speaking, before going out on a Halloween night, children will dress up in costume and/or makeup, often with their parent's assistance. The costumes may involve the wearing of masks or head gear which may reduce the child's ability to see. Furthermore, the children will generally wait until dusk before proceeding out. As a result, there is a real possibility that children may get involved in a traffic accident as a result of crossing a street.

In order to make Halloween trick-or-treating safer for children, parents often require their children to wear light emitting flashers. Alternatively, they ask their children to carry flash lights or other illuminated lamps. While these items do make the child more visible, and therefore, increase their safety, children are often reluctant to carry lamps, flashers or flash lights because they are bulky and because they are difficult to carry. Recently, manufacturers have introduced plastic Halloween buckets incorporating some sort of illuminating device, such as a lamp or chemical luminescent device. For example, U.S. Pat. No. 5,984,754 to Freelander discloses an illuminated toy bucket in the shape of a Halloween jack-o-lantern which incorporates a chemiluminescent wand. The chemiluminescent wand generates light through a chemical reaction, and when inserted into the bucket, causes the bucket to glow. Similarly, U.S. Pat. No. 6,431,724 B1 to Tedham et al. and U.S. Pat. No. 5,567,054 to Dalgleish, disclose illuminated bags which incorporate a chemiluminescent wand to generate light to make the bag more visible. U.S. Pat. No. 4,802,071 to Schuster discloses a lantern candy carrier in the shape of a jack-o-lantern which incorporates a battery powered light to cause the carrier to glow.

While these prior art illuminated bags and buckets do make the user a little more visible in the dark, the prior art suffers from a few significant drawbacks. Firstly, all of the prior art illuminated buckets/bags involve the use of either chemiluminescent wands or battery operated lights. These devices tend to be fairly expensive, costing at least several dollars each. Unfortunately, most consumers are not prepared to spend several dollars on what is essentially a plastic bag or bucket. Also, these devices often do not produce a significant amount of light for a sufficiently long period of time to make them truly useful for trick-or-treating. As a result, an improved Halloween bag is required. Devices with glow sticks may actually produce a more intense glow, but the glow is not spread over the entire surface area of the object intended to be illuminated. Devices using a chemiluminescent wand are also not reusable, in that a new wand must be purchased and only provides one time usage.

### SUMMARY OF THE INVENTION

In accordance with the present invention, there is provided a glow in the dark trick-or-treat bag made of an envelope of a flexible material, the envelope having sealed side edges, a sealed bottom and an open top. The flexible material being a mixture of a polymeric material with a glow in the dark additive.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a front view of a trick-or-treat bag made in accordance with the invention.

FIG. 2. is a cross sectional view of the sheet material used to construct the trick-or-treat bag shown in FIG. 1.

FIG. 3. is a cross sectional view of an alternate embodiment of the sheet material used to construct the trick-or-treat bag shown in FIG. 1.

FIG. 4. is a graphical representation showing the luminance as a function of time for a variety of sheet materials used to construct the trick-or-treat bag of the present invention.

FIG. 5. is a graphical representation showing the luminance as a function of time for a variety of sheet materials used to construct the trick-or-treat bag of the present invention.

FIG. 6. is a table showing the data points used in constructing the graphical representations of FIGS. 4 and 5.

FIG. 7. is a graphical representation showing the relationship between the dart impact strength of a sheet material used to construct the trick-or-treat bag of the present invention as a function of glow additive concentration.

FIG. 8. is a graphical representation showing the relationship between the tensile strength of a sheet material used to construct the trick-or-treat bag of the present invention as a function of glow additive concentration.

FIG. 9. is a graphical representation showing the relationship between the tensile strength at break of a sheet material used to construct the trick-or-treat bag of the present invention as a function of glow additive concentration.

FIG. 10. is a graphical representation showing the relationship between the Elmendorf Tear strength of a sheet material used to construct the trick-or-treat bag of the present invention as a function of glow additive concentration.

FIG. 11. is a graphical representation showing the relationship between the Puncture strength of a sheet material used to construct the trick-or-treat bag of the present invention as a function of glow additive concentration.

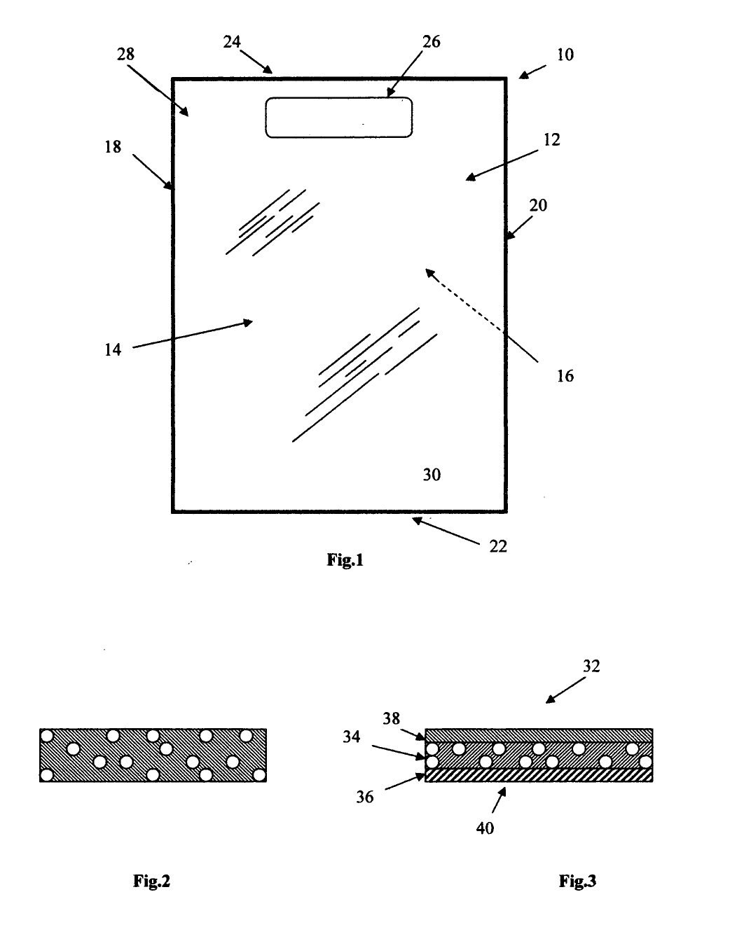

In the drawings like characters of reference indicate corresponding parts in the different figures.

### DETAILED DESCRIPTION OF THE INVENTION

Referring firstly to FIG. 1, a trick-or-treat bag made in accordance with the present invention is shown generally as item 10 and consists of an envelope 12 formed from flexible sheets 14 and 16 which are bonded together along side edges 18 and 20 and along bottom edge 22. Bag 10 has an open top 24 and a handle 26 cut out of top end 28 which is adjacent open top 24. A decorative design or logo (not shown) may be printed directly onto surface 30 of sheet 14 and or onto the surface of sheet 16.

Sheets 14 and 16 consist of a film made from a polymeric base material incorporating a photoluminescent additive. The polymeric base material may consist of a polyethylene material, for example high pressure low density polyethylene, linear low density polyethylene, medium density polyethylene, high density polyethylene, high molecular weight high density polyethylene, and/or metallocene based polyolefins. Alternatively, a polypropylene material may be used (such as random copolymer polypropylene, homopolymer polypropylene, or oriented polypropylene) or even a polyester based material may be used. The photoluminescent additive may be a phosphorescent material such as zinc sulfide or strontium aluminate.

Sheets 14 and 16 may be formed from either a monolayer film or from a multilayered film. If a monolayer film is used, then the composition of the polymeric material and the concentration of the photoluminescent additive must be selected to ensure that the sheets can be printed and to ensure that the finished bag will have sufficient structural strength to permit it to store a quantity of candy, fruit, or other trick-or-treat items. Generally speaking, the concentration of the photoluminescent additive will be approximately 25%. As discussed below, it has been discovered that sheets having photoluminsecent additive values of below 12% of a 50% master batch (i.e. 6% total glow additive concentration) did not provide acceptable glow intensity and glow times and that values up to 50% of a 50% master batch (i.e. 25% total glow additive concentration) provided acceptable glow. It has also been discovered that the glow times did not greatly increase past a final glow additive concentration of 25%.

It has been discovered that in order to be serviceable as a trick-or-treat bag, the bag must glow for at least 4 hours. Statistically speaking, a large percentage of children go trick-or-treating for 4 hours or less. Since the average child leaves to go trick-or-treating at dusk, it is statistically likely that many children will be out in the evening for at least two or more hours after it has become dark. It is also quite likely, that at any given trick-or-treat evening, a significant percentage of children will be out in the dark for approximately 4 hours. Therefore, to be effective as a child safety aid, the finished bag must continue to glow for a full 4 hours, or else children using the bag may be left in the dark without illumination.

The threshold of human vision is only 0.01 mcd/m². This is assuming a night adapted eve in total darkness. However, for safety reasons, a glowing trick or treat bag should be as bright as possible in order to distinguish the bag (and the child holding it) during busy street traffic. Preferably, the bag should have a luminance of close to 50 mcd/m² or more after 240 minutes of glowing. Of course, to be serviceable as a trick-or-treat bag, the material forming the bag must have good physical characteristics, an in particular, the material must have good tensile strength. In order to do this, while at the same time providing a bag which will have sufficient structural strength to make it useful for carrying items, the sheets making up the bag must have certain physical as well as chemical characteristics. If the sheets making up the trick-or-treat bag are made from a mono-layer film, then the concentration of photoluminescent material used and the thickness of the film must be carefully selected. Generally speaking, the thickness of the film should be approximately between about 2 mil (0.002″, 51 microns) and 4. mils (0.004″, 102 microns) in order to be sufficiently flexible and strong. If the film has a thickness of less than 0.002″, then the finished bag may not have sufficient structural strength to be practical. However, if the thickness of the film exceeds 0.004″, then the bag would be too stiff to be flexible and the finished bag would also be too expensive to construct since it would use up too much plastic.

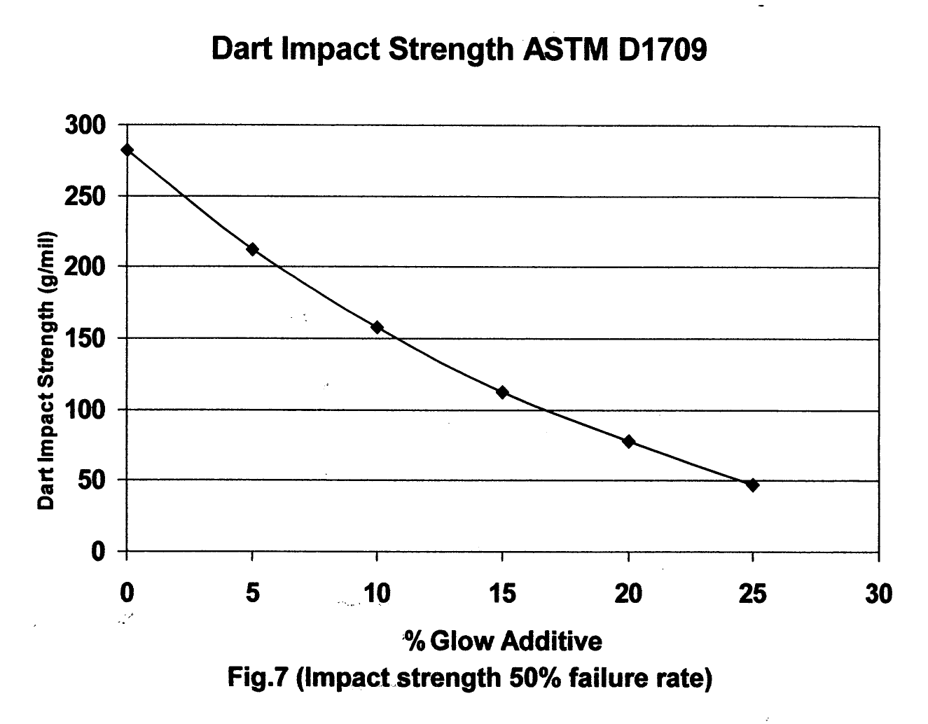

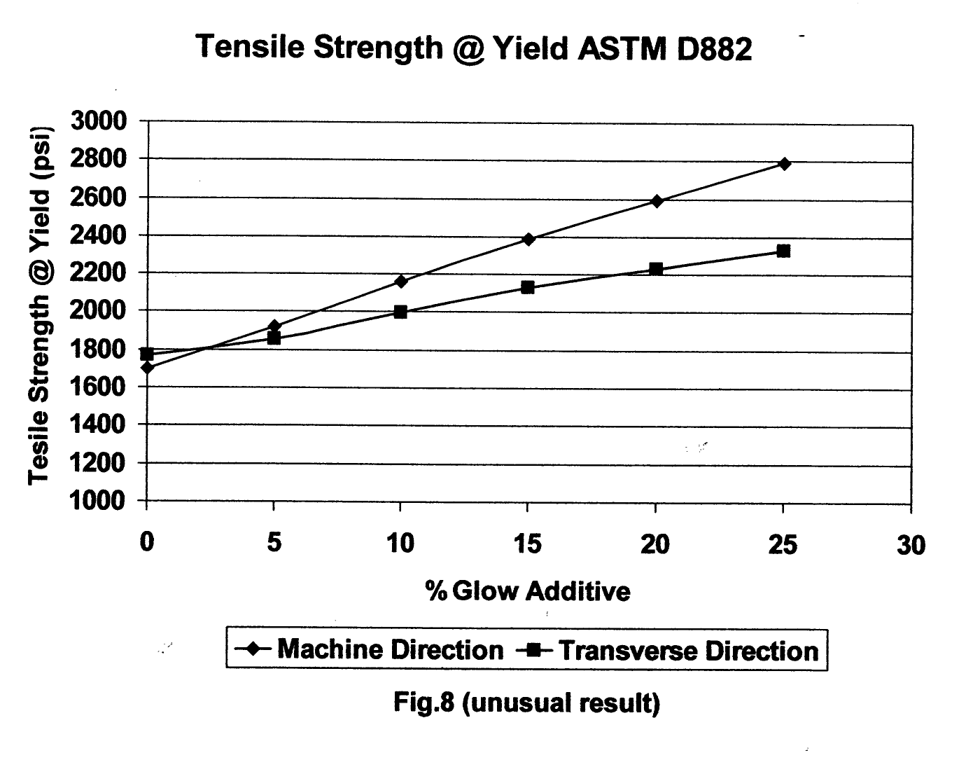

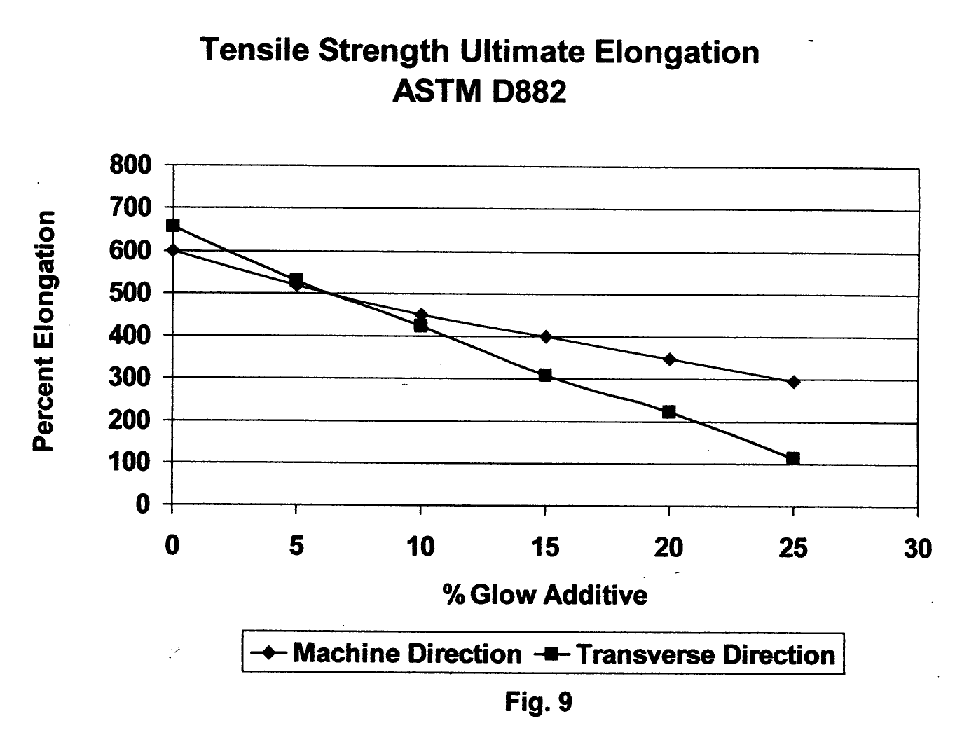

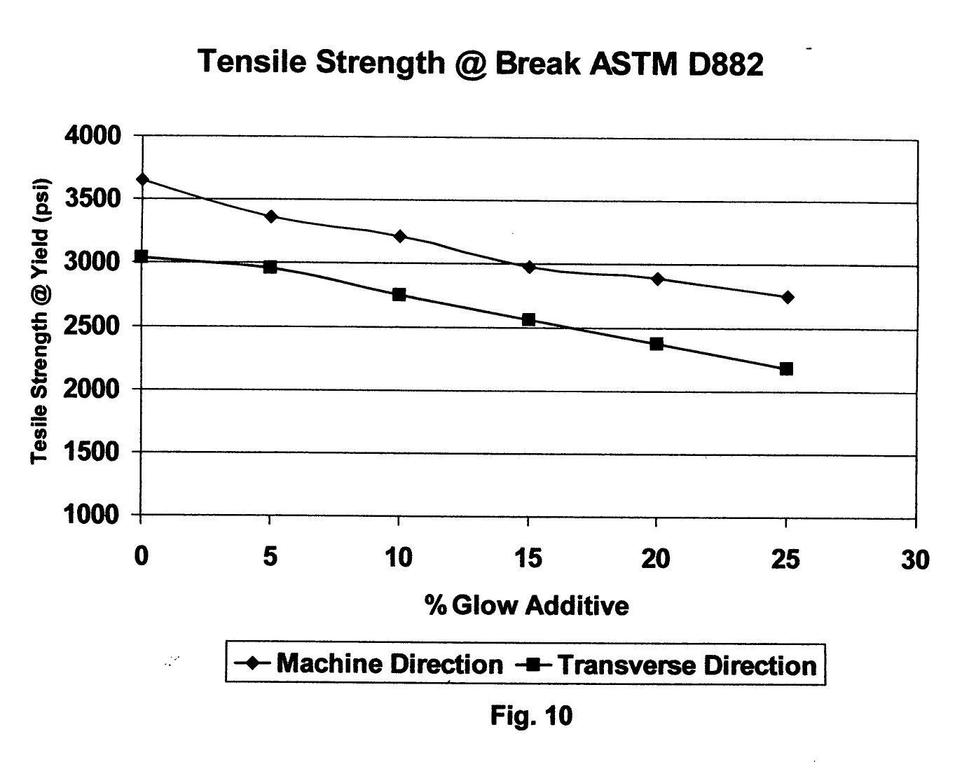

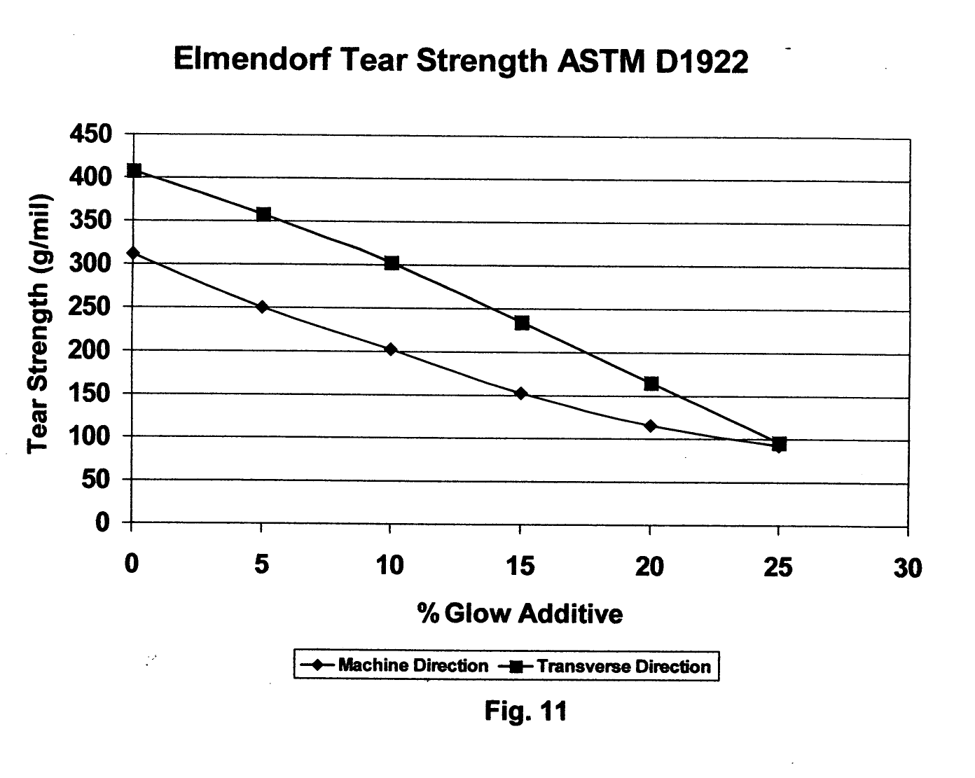

In order to create a mono-layer sheet material suitable for use in making glowing trick-or-treat bags, tests were conducted to determine the optimal amount of glow additive which could be added to a base material (LLDPE) and the effect of the glow additive on the physical characteristics of the sheet produced. The glow additive used was Indigo™ glow additive which is a commercially available glow additive consisting of a base styrene-butadiene copolymer together with a glowing compound such as phosphorous and strontium glow compound. Other suitable glow additives, such as Fortrex™ may also be used. It was anticipated that as the concentration of glow additive increased, the physical characteristics of the resulting sheet would decrease. As can be seen from the graphs shown in FIGS. 7, 9, 10 and 11, the dart impact strength, tensile strength at break. Elmendorf tear strength and puncture strength decreased markedly as the glow additive concentration approached 25%. However, quite surprisingly the tensile strength at yield actually increased as the percentage of glow additive increased (see FIG. 8). Also, from FIGS. 4 and 5 we can see that glow times exceeding 240 minutes (at or near 50 mcd/m²) can be achieved using glow additive concentrations of 25% (particularly at 4 mil thickness). Since the tensile strength of the plastic sheet used to manufacture the trick-or-treat bag is the single most important consideration governing the performance of the trick-or-treat bag, the incorporation of the glow additive actually improves the physical performance of the bag.

If the concentration of the photoluminescent material is lower than approximately 6%, then in order to obtain a glow time of at least 4 hours, the film would have to be made to a thickness of greater than 0.004″. It has been discovered that films having the characteristics summarized in table 1 are useful in constructing trick-or-treat bags with at least a 4 hour glow time with a glow intensity of at least 50 mcd/m² after four hours of glowing.

TABLE 1
Composition and Thickness of Monolayer Photoluminescent Film

| | Photoluminescent | % photo- | |
|---|---|---|---|
| | additive | luminescent | |
| | material (as | additive | film |
| Polymeric material | Indigo additive) | in film | thickness |
| high pressure | strontium earth | 25% Total | minimum of |
| low density | aluminate | Concentration | 2.0 mils |
| polyethylene | | 19% Total | minimum of |
| | | Concentration | 3.0 mils |
| | | 12% Total | minimum of |
| | | Concentration | 4.0 mils |
| linear low density | strontium earth | 25% Total | minimum of |
| polyethylene | aluminate | Concentration | 2.0 mils |
| | | 19% Total | minimum of |
| | | Concentration | 3.0 mils |
| | | 12% Total | minimum of |
| | | Concentration | 4.0 mils |
| medium density | strontium earth | 25% Total | minimum of |
| polyethylene | aluminate | Concentration | 2.0 mils |
| | | 19% Total | minimum of |
| | | Concentration | 3.0 mils |
| | | 12% Total | minimum of |
| | | Concentration | 4.0 mils |
| high density | strontium earth | 25% Total | minimum of |
| polyethylene | aluminate | Concentration | 2.0 mils |
| | | 19% Total | minimum of |
| | | Concentration | 3.0 mils |
| | | 12% Total | minimum of |
| | | Concentration | 4.0 mils |
| high molecular weight | strontium earth | 25% Total | minimum of |
| high density | aluminate | Concentration | 2.0 mils |
| polyethylene | | 19% Total | minimum of |
| | | Concentration | 3.0 mils |
| | | 12% Total | minimum of |
| | | Concentration | 4.0 mils |
| polypropylene | strontium earth | 25% Total | minimum of |
| | aluminate | Concentration | 2.0 mils |
| | | 19% Total | minimum of |
| | | Concentration | 3.0 mils |
| | | 12% Total | minimum of |
| | | Concentration | 4.0 mils |
| metallocene catalyzed | strontium earth | 25% Total | minimum of |
| polyethylene | aluminate | Concentration | 2.0 mils |
| | | 19% Total | minimum of |
| | | Concentration | 3.0 mils |
| | | 12% Total | minimum of |
| | | Concentration | 4.0 mils |
| ultra low density | strontium earth | 25% Total | minimum of |
| polyethylene | aluminate | Concentration | 2.0 mils |
| | | 19% Total | minimum of |
| | | Concentration | 3.0 mils |
| | | 12% Total | minimum of |
| | | Concentration | 4.0 mils |
| polyethylene and | strontium earth | 25% Total | minimum of |
| polypropylene blends | aluminate | Concentration | 2.0 mils |
| | | 19% Total | minimum of |
| | | Concentration | 3.0 mils |
| | | 12% Total | minimum of |
| | | Concentration | 4.0 mils |
| ethylene vinyl acetate | strontium earth | 25% Total | minimum of |
| copolymers | aluminate | Concentration | 2.0 mils |
| | | 19% Total | minimum of |
| | | Concentration | 3.0 mils |
| | | 12% Total | minimum of |
| | | Concentration | 4.0 mils |

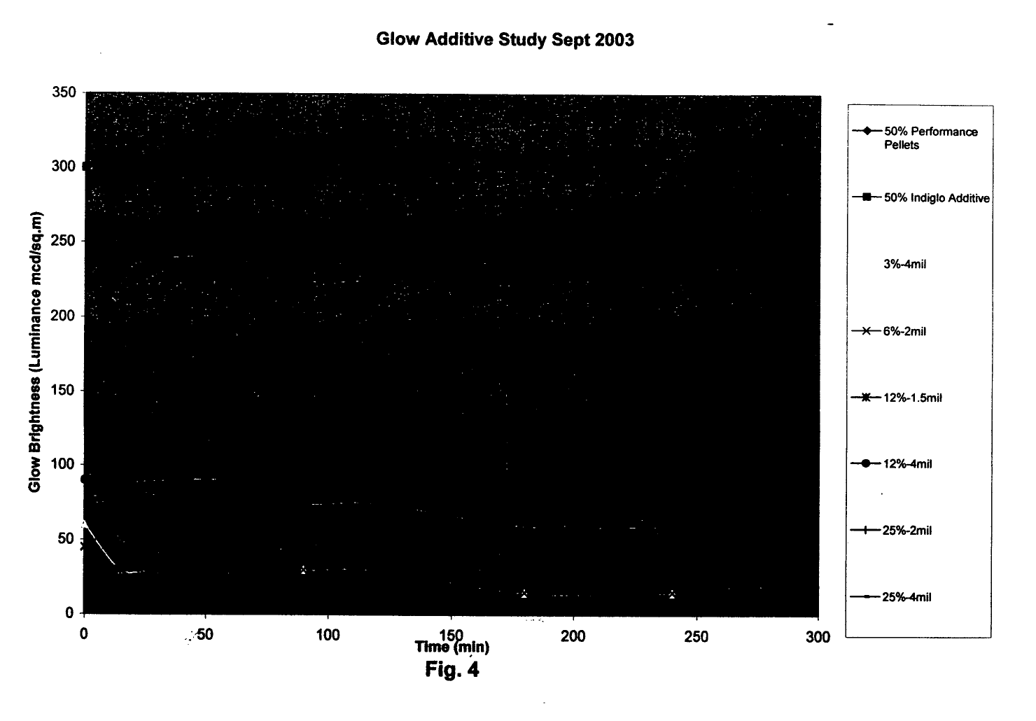

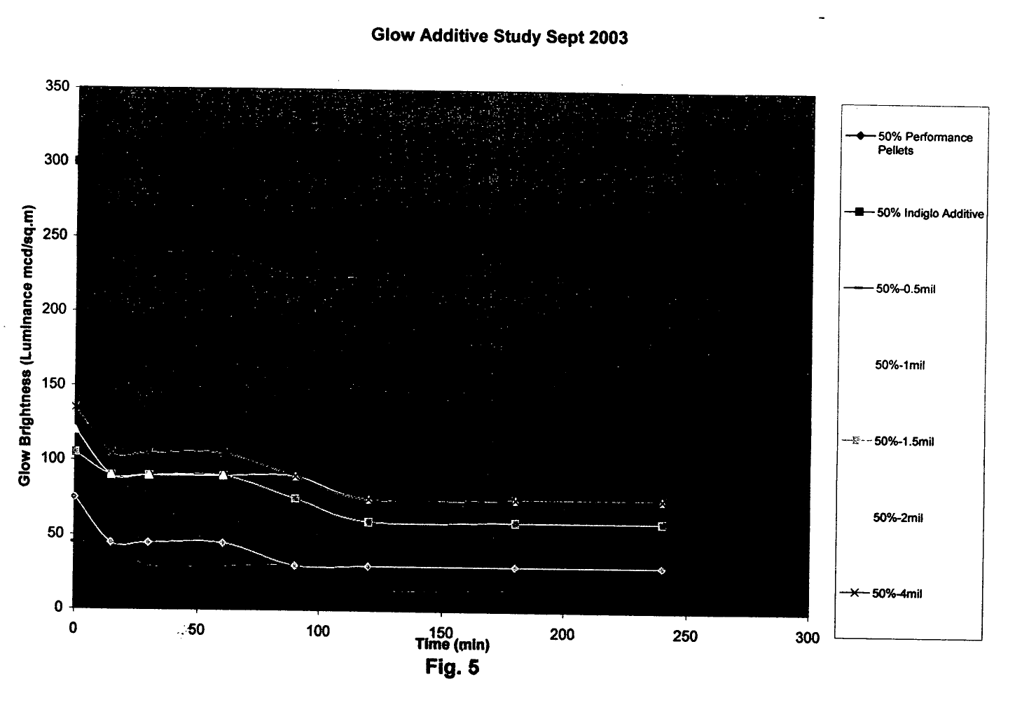

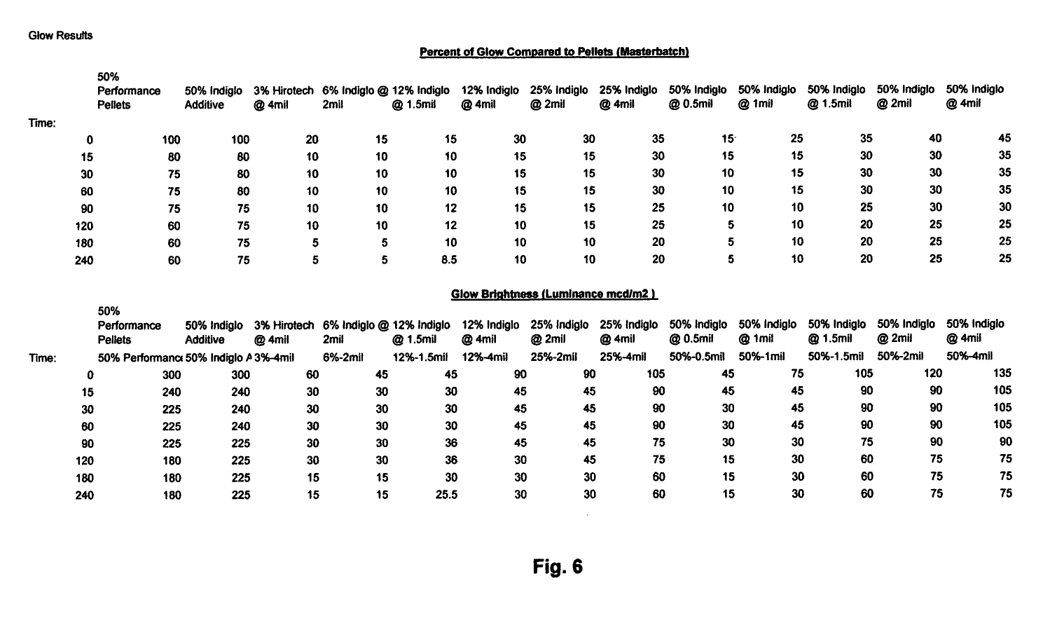

An effective photoluminescent sheet can also be made from a multilayered film. Such a film can have a photoluminescent layer consisting of a photoluminescent material incorporated into a polymeric material. The film can also include a structural layer, for giving added strength to the film, for providing a pigmented and reflective background and/or an additional layers which are suitable for printing or protection. FIG. 3 shows a photoluminescent sheet made from three layered film. Film 32 consists of a photoluminescent layer 34 sandwiched between a structural and reflective layer 38 and a printable layer 36. Structural layer 38 may consist of a polymeric material having high strength, such as oriented polypropylene or some other suitable high strength polymeric material. The thickness and composition of structural layer 38 is selected to ensure that the structural layer provides a majority of the structural strength of the film. The structural layer should also be configured to reflect light produced from the glow additive, towards the outside of the bag. This is achieved by producing an opaque structural layer using white pigment (titanium dioxide) or by the addition of foil or metalized polymer, in this layer. Photoluminescent layer 34 consisting of a mixture of a polymeric material and a photoluminescent material. Since structural layer 38 provides a majority of the structural strength to the film, photoluminescent layer 34 does not have to have good strength characteristics, and may therefore include a higher concentration of photoluminescent material. Printable layer 36 consists of a thin layer of a low haze polymeric material (preferably with a haze value of less than 10, ASTM D1003), so that the photoluminescent layer is clearly visible through the printable layer. Suitable polymeric materials for forming printable layer 36 include high pressure low density polyethylene, linear low density polyethylene, and/or metallocene based polyolefins formulated with or without slip additive such as erucamide or stearamide, and antiblocking additives, such as talc, diatomaceous earth, and silicone dioxide. Careful considerations must be made to preserve the optical and printable properties of this layer when formulating with slip and antiblocking additives.

To add to the functionality of the multilayered film, structural layer 38 may be highly reflective. For example, structural layer 38 may comprise a layer of metalized oriented polypropylene or metalized polyester. The highly reflective layer will enhance the luminous qualities of the finished bag. Not only will the reflective layer reflect the light generated from the luminous layer, but it will also reflect back light from approaching car headlights, making the finished bag much more visible.

Layers 34, 36 and 38 may be formed as separate films which are then adhesive laminated or extrusion laminated, bonded or heat sealed together. Alternatively, film 32 can be formed by co-extrusion. The following is a list of suitable materials for use in forming multilayer films:

For Two Layered Structures:

LDPE (LLDPE, MDPE, HDPE, mLLDPE, PP, OPP, PET, metallized OPP or PET) with white pigment for the reflective layer and LDPE (LLDPE, mLLDPE, PP) with photoluminscent additives for the glow layer. The glow layer can be printed on.
LDPE (LLDPE, MDPE, HDPE, mLLDPE, PP, OPP, PET, metallized OPP or PET) with white pigment for the reflective layer which may be printed on and LDPE (LLDPE, mLLDPE, PP) with photoluminscent additives for the glow layer.
   Three Layer Structures
LDPE (LLDPE, MDPE, HDPE, mLLDPE, PP, OPP, PET, metallized OPP or PET) with white pigment as the reflective layer, LDPE (LLDPE, mLLDPE, PP) with photoluminscent additives for the glow layer and LDPE (LLDPE, mLLDPE, PP) as the printable layer.
LDPE (LLDPE, MDPE, HDPE, mLLDPE, PP, OPP, PET, metallized OPP or PET) with white pigment as the reflective layer, LDPE (LLDPE, mLLDPE, PP) with photoluminscent additives as the glow layer and LDPE (LLDPE, mLLDPE, PP) as the printable layer.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. A glow in the dark trick-or-treat bag comprising an envelope made of a sheet material, the envelope having sealed side edges, a sealed bottom and an open top, the sheet material comprising a film made of a mixture of a polymeric material with a photoluminescent additive.

2. The glow in the dark trick-or-treat bag of claim 1 wherein the film has a thickness of between approximately about 0.001″ (25 microns) and about 0.006″ (152 microns) and wherein the film has a photoluminescent material concentration of between about 7% and about 50%.

3. The glow in the dark trick-or-treat bag of claim 1 wherein the film has a thickness of between about 0.002″ and about 0.004″ and wherein the film has a photoluminescent additive concentration of about 25%.

4. The glow in the dark trick-or-treat bag of claim 1 wherein the film has a thickness of about 0.004″ and wherein the film has a photoluminescent additive concentration of about 25%.

5. The glow in the dark trick-or-treat bag of claim 1 wherein the film has two layers, a reflective layer made of a polymeric material having a reflective pigment and a glow layer made from a polymeric material with a photoluminescent material additive.

6. The glow in the dark trick-or-treat bag of claim 5 wherein glow layer has a thickness of between about 0.001″ and about 0.006″ and wherein the concentration of the photoluminescent additive is between about 7% to about 50%.

7. The glow in the dark trick-or-treat bag of claim 5 wherein the glow layer has a thickness of between about 0.002″ and about 0.004″ and wherein the concentration of the photoluminescent additive is between about 25% to about 50%.

8. The glow in the dark trick-or-treat bag of claim 5 wherein the glow layer has a thickness of about 0.004″ and wherein the concentration of the photoluminescent additive is about 25%.

9. The glow in the dark trick-or-treat bag of claim 1 wherein the film comprises a three layered film having a reflective layer, a clear layer and a glow layer between the clear and reflective layer.

10. The glow in the dark trick-or-treat bag of claim 9 wherein glow layer has a thickness of between about 0.001″ and about 0.006″ and wherein the concentration of the photoluminescent additive is between about 7% to about 50%.

11. The glow in the dark trick-or-treat bag of claim 10 wherein the glow layer has a thickness of between about 0.002″ and about 0.004″ and wherein the concentration of the photoluminescent additive is between about 25% to about 50%.

12. The glow in the dark trick-or-treat bag of claim 9 wherein the glow layer has a thickness of about 0.004″ and wherein the concentration of the photoluminescent additive is about 25%.

13. A glow in the dark trick-or-treat bag comprising an envelope made of two sheets, at least one of said sheets being made of a glow in the dark film, the envelope having sealed side edges, a sealed bottom and an open top, the glow in the dark film comprising a flexible film made of a mixture of a polymeric material with a photoluminescent additive, the film having a thickness of between 0.001″ and 0.006″ and wherein the concentration of the photoluminescent additive is between about 7% to about 50%.

14. A glow in the dark trick-or-treat bag as defined in claim 13 wherein the glow in the dark film has a thickness of between 0.002″ and 0.004″ and wherein the concentration of the photoluminescent additive is between about 25% to about 50%.

15. The glow in the dark trick-or-treat bag of claim 13 wherein the glow in the dark film has a thickness of about 0.004″ and wherein the concentration of the photoluminescent additive is about 25%.

16. A glow in the dark trick-or-treat bag comprising an envelope made of two sheets, at least one of said sheets being made of a glow in the dark film, the envelope having sealed side edges, a sealed bottom and an open top, the glow in the dark film comprising a multi-layered flexible film, at least one of said layers being a glow layer made of a mixture of a polymeric material with a photoluminescent additive, the glow layer having a thickness of between 0.001″ and 0.006″ and wherein the concentration of the photoluminescent additive is between about 7% to about 50%.

17. A glow in the dark trick-or-treat bag as defined in claim 16 wherein the multi-layered film includes a reflective layer made of a mixture of a polymeric material and a reflective additive.

18. A glow in the dark trick-or-treat bag as defined in claim 16 wherein the multi-layered film includes a clear layer made of a polymeric material.

19. A glow in the dark trick-or-treat bag as defined in claim 17 wherein the multi-layered film further includes a clear layer made of a polymeric material, the glow layer being sandwiched between the reflective layer and the clear layer.

20. A glow in the dark trick-or-treat bag as defined in claim 19 wherein the glow layer has a thickness of between 0.002″ and 0.004″ and wherein the concentration of the photoluminescent additive is between about 25% to about 50%.
